(19) United States
(12) Patent Application Publication
(10) Pub. No.: US 2013/0033609 A1
(43) Pub. Date: Feb. 7, 2013

(54) Multifunctional Flashlight

(71) Applicant: Robespierre Philippe Cadeus, Dorchester, MA (US)

(72) Inventor: Robespierre Philippe Cadeus, Dorchester, MA (US)

(21) Appl. No.: 13/196,259

(22) Filed: Aug. 2, 2011

(51) Int. Cl. H04N 5/225

(52) U.S. Cl. 348/207.1; 348/E05.024

(57) ABSTRACT

A LED multifunctional duty flashlight having a video recorder and a metal detector. A flip video screen is rotatabaly mounted on the outside of wall of the elongate body, and SD card cord and USB cord are built on the wall to provide data downloading to external device and for recharging a battery. LED panel is mounted on the front section and is controlled by its own power switch.

### FIELD OF THE INVENTION

The present application relates to a hand-held flashlight, and more particularly to a rechargeable LED flashlight that embodies multiple other functions besides lighting.

Note that the points discussed below may reflect the hindsight gained from the disclosed inventions, and are not necessarily admitted to be prior art.

Many professions require carrying flashlight as a necessary tool, for example, law enforcement officers are required to carry a “duty lights,” special military personals may be required to carry a flashlight for night operations, long distance drivers may be required to carry a flashlight for road safety reasons. As digital technology advances, people are able to add more functions to conventional flashlights, providing increased convenience for flashlight users.

For example, the US Patent Application Publication No. US 2011/0103047 A1 describes LED flashlights that use infrared LEDs and ultraviolet LEDs, Global Positioning System tracking component and radio component. More, PCT Publication No. WO 2011/059849 describes a water resistant flashlight that contains audio and video recording functionalities.

However, for law enforcement and other safety operations, a metal detector function is also desirable.

### SUMMARY OF THE INVENTION

The present application discloses a novel rechargeable LED flashlight that includes a camera and cam recorder function as well as a metal detector function.

In one embodiment, a flashlight has a front section for providing light source, a middle elongate housing for providing multiple functions and a rear section for power control. The elongate housing is mounted with an external rotatable flip video screen for a built-in digital camera and cam recorder function while the electronic processing chips for camera and cam recorder are mounted inside the elongated housing. A touch sensitive screen similar to that of a smart phone may be mounted on the exterior surface of the housing body.

In another embodiment, a metal detector is disposed along one side of the interior wall in the elongate housing.

In one aspect of an embodiment, a plurality of arrays of light emitting diodes (LEDs) are mounted on the front section of the elongate body for providing light source for lighting targets. The LED arrays are connected with rechargeable batteries mounted inside the elongate housing.

In another aspect of an embodiment, cords for Secure Digital (SD) memory card, USB cable for recharging the battery or down loading digital video or pictures or an AV cord to TV are built on the wall of the elongate housing.

The disclosed metal detector enabled LED flashlight design provides convenient functions compacted and organized within one portable flashlight, enabling it to be a great safety tool, especially for law enforcement officers and military persons.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 shows a prospective view of an example multifunctional flashlight in accordance with this application.

FIG. 2 shows a front sectional view of an example multifunctional flashlight in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

It is contemplated and intended that the design apply to any suitable material for making a product, the shape the body may be tubular, cylindrical or multi-edged for easy holding. For clarity reason, the examples are given in cylindrical shape, but an ordinary person in the art would know the variations to modify the design to make other shapes.

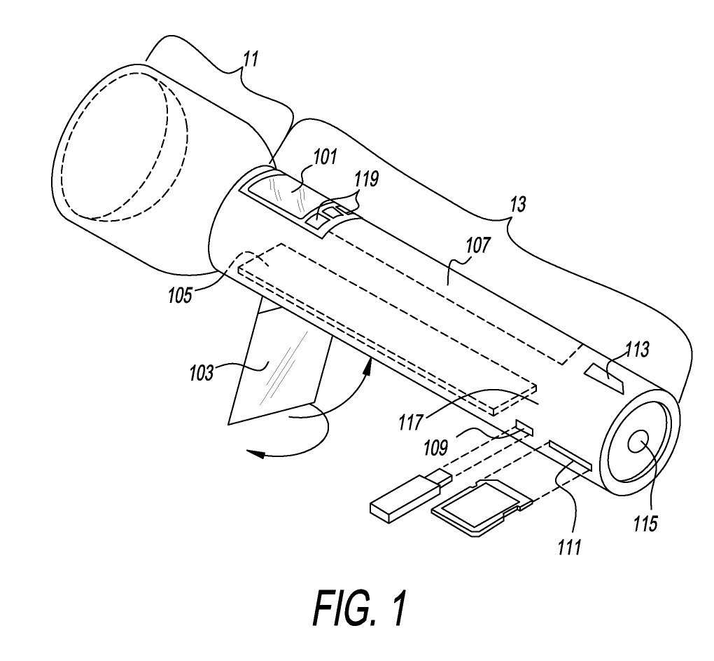

In reference to FIG. 1, portable multifunctional flashlight 10 includes a front section 11, an elongate cylindrical housing body 13, and a rear cap section 15. These three sections can be totally sealed for water resistance or removably interconnected at their interfaces. Front section 11 may be constructed the same way as a conventional LED flashlight, comprising light diffuser cap and lens. However, a small camera lens for video recorder and camera may be mounted behind a front mounting plate in a known fashion.

Inside elongate housing body 13, several functional modules are mounted and electronically connected together to provide an integrated multifunctional flashlight. On the exterior wall surface of housing body 13, touch sensitive screen 101 similar to that of a smart phone is mounted on the exterior surface of housing body 13. The screen and camera lens are connected to computer processing unit 107 for data processing and controlling. Screen 101 may comprise several touch buttons 119, and display a menu of functions in operating the flashlight. On the exterior wall surface of housing body 13, is also mounted rotatable video flip screen 103 for capturing and viewing a video sequence or photo pictures. Screen 103 may flip up to a storage compartment configured on the wall of housing 13 or alternatively slide inside into the housing body for storage. It may rotate pivotally for showing and viewing from different angles. The video screen is electronically connected with the computer processing unit 107.

Inside housing body 13, a metal detector 105 is mounted at one side the housing, on and close to the interior wall. Metal detector 105 is connected to computer processing unit 107, and the detection of metal may be alarmed through a speaker or be shown on the video screen or the menu screen 101. The structure of metal detector 105 can be conventionally constructed, an example of such may be found in US Patent Publication No. US 2011/0109404 A1, the entirety of which is therefore incorporated by reference.

SD cord 111, USB cord 109, an AV cord to TV 113 may be also built as integral part of flashlight 10 to provide extra memory and connections for external devices. USB cord 109 may also be used to charge rechargeable battery, similar to many cell phone structure. Status of battery may be indicated with an indicator light 117. All these connections are connected to the computer processing unit 107 in a known way. Built in computer programs installed in computer processing unit 107 will control the operation of digital camera, and cam recorder function, metal detector, data processing and downloading, etc, in a known way similar to a smart cell phone. Power control 115 may be set on the rear section cap 15 to turn the whole system on or off. Rechargeable batteries are housed inside elongate body 13 for providing electricity power to all functional units.

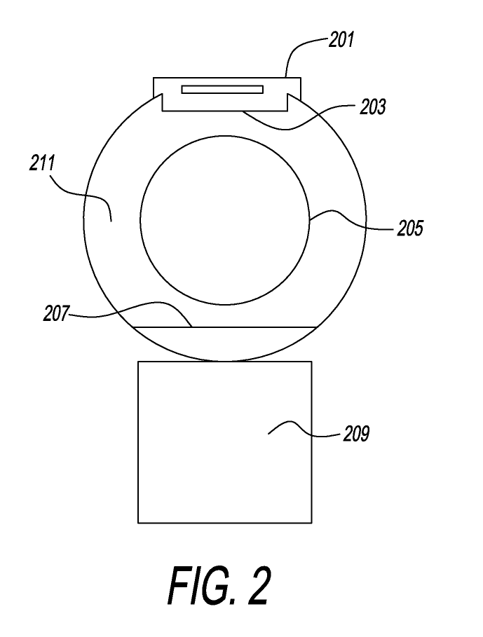

In reference to FIG. 2, a front sectional view of the flashlight 10 indicates video lens 211 mounted inside the front plate, arrays of LEDs 205 are visible from the front plate, their power switch may be separate from rest of the functional unit and the computer processing unit, therefore are simply controlled by turning on and off a switch, like the conventional flashlight. Menu screen 201, computer processing unit 203, metal detector mechanism 207 and video screen 209 are all electronically connected through computer processing unit 203 and are controlled by the computer program pre-installed in computer processing unit 203. The computer program integrates known controlling processes for each of the functional module, and enables them to function together seamlessly.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Additional general background, which helps to show variations and implementations, may be found in the following patent application publications, all of which are hereby incorporated by reference herein for all purposes: WO 2011/059849, US 2011/0103047 A1, U.S. Pat. No. 7,938,555 B1, and US 2011/0109404 A1.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A portable multifunctional flashlight having arrays of LEDs as lighting source, comprising:
an elongate housing body forming a tubular sealed housing space, having a wall with exterior surface,
a digital camera module capable of video recording, disposed inside said housing space;
a metal detector module disposed inside said housing space; and
a computer processing unit disposed inside said housing space, wherein said digital camera module and said metal detector module are electronically connected to said computer processing unit, and are controlled by a pre-installed computer software program.

2. The portable multifunctional flashlight of claim 1, further comprising:
a flip video screen pivotally and rotatably mounted on said exterior surface of said wall of said housing body, electronically connected with said camera module, wherein a picture is viewed on said video screen, and said screen is placed at a storage position by flipping the screen towards said housing body.

3. The portable multifunctional flashlight of claim 1, further comprising:
a menu screen disposed on said exterior surface inside said wall, electronically connected with said computer processing unit, wherein said screen displays functional choices.

4. The portable multifunctional flashlight of claim 1, further comprising:
a USB cord disposed on said wall for recharging a battery pre-disposed inside said housing space.

5. The portable multifunctional flashlight of claim 1, further comprising:
SD card cord disposed on said wall.

6. The portable multifunctional flashlight of claim 1 is configured to be water resistant.

7. The portable multifunctional flashlight of claim 1, wherein said LED light source is controlled by its separate power switch.
